(19) United States
(12) Patent Application Publication
(10) Pub. No.: US 2025/0133174 A1
(43) Pub. Date: Apr. 24, 2025

(54) TRANSMISSION OF SCANNED DOCUMENT TO DIFFERENT DESTINATIONS USING DIFFERENT SIZE FILES

(71) Applicant: Hewlett-Packard Development Company, L.P., Spring, TX (US)

(72) Inventors: Jaein LEE, Seongnam Si (KR); Eunkyung YUN, Seongnam Si (KR); Peter G. HWANG, Vancouver, WA (US); Kabdeuk KIM, Seongnam Si (KR); Younghoon SON, Seongnam Si (KR); Hannam KIM, Seongnam Si (KR)

(21) Appl. No.: 18/690,058

(22) PCT Filed: Sep. 10, 2021
(86) PCT No.: PCT/US2021/049782

§ 371 Date: Mar. 7, 2024

(51) Int. Cl. H04N 1/32; H04N 1/00

(52) U.S. Cl. CPC H04N 1/32374; H04N 1/00244; H04N 1/32475

(57) ABSTRACT

An example image forming apparatus includes a scan unit to output digital image data of a scanned document, a user interface unit to receive an input of a first destination and a second destination for sending the scanned document, a processor to generate a first file having a first size based on the digital image data, and to generate a second file having a second size, the second size being smaller than the first size, based on the digital image data, a storage unit to store the first file and the second file, and a communication unit to transmit the first file to the first destination and the second file to the second destination.

### BACKGROUND

A scan unit may be a stand-alone device or may be included in an image forming apparatus (IFA) that also includes a copier, a printer, and a facsimile. A document that is scanned by the scan unit may undergo image processing to generate a corresponding image file for transmission to a destination or a recipient. A user may select multiple destinations or recipients of the image file and the image file may be provided to the selected multiple destinations or recipients.

### BRIEF DESCRIPTION OF THE DRAWINGS

Various examples will be described below by referring to the following figures.

FIG. 1 illustrates a system including an image forming apparatus to provide files of different sizes to different destinations according to an example.

FIG. 2 illustrates an image forming apparatus according to an example.

FIG. 3 illustrates an operation of an image forming apparatus to provide a scanned image to multiple destinations according to an example.

FIG. 4 illustrates a user interface to receive parameters for a scan job according to an example.

FIG. 5 illustrates a destination setting menu according to an example.

FIG. 6 illustrates a smaller file setting menu according to an example.

FIG. 7A illustrates different options and associated pre-set parameters according to an example and FIG. 7B illustrates a help screen that may be displayed to assist a user in selecting an option having pre-set parameters according to an example.

FIG. 8 illustrates an operation of a processor for optionally generating a first file and a second file according to an example.

FIG. 9 is a diagram illustrating instructions stored in a computer readable recording medium according to an example.

### DETAILED DESCRIPTION

Hereinafter, various examples will be described with reference to the drawings. Like reference numerals in the specification and the drawings denote like elements, and thus a redundant description may be omitted.

A scan unit may be a stand-alone device or may be included in an image forming apparatus that also includes a copier, a printer, a facsimile, and other components. In operation, a user may provide a document to be scanned to the scan unit, select parameters for a scanning operation, and select multiple destinations (e.g., recipients) to receive the scanned document. The scan unit scans the document to create digital image data, the selected parameters are applied to the digital image data to obtain a scanned file, and the scanned file is transmitted to each of the selected multiple destinations.

A size of the scanned file corresponds to the selected parameters that are applied to the digital data. For example, a resolution parameter of 600 dots-per-inch (dpi) will result in a larger scanned file than a resolution parameter of 300 dpi. Similarly, a lossless compression parameter will result in a larger scanned file than a lossy compression parameter. And while the scanned file having the larger size may have a higher image quality than the scanned file having a smaller size, the larger size file may be unnecessary or undesired for a certain destination.

In various examples as described below, a scanned document may be provided to different destinations (e.g., recipients) using files of different sizes. In that case, a first file having a first size may be provided to a first destination while a second file having a second size that is smaller than the first size may be provided to a second destination. By providing files of different sizes, system performance and user convenience may be enhanced by using the second file having a smaller size. In the following description, a size of a file refers to the amount of data included in the file or how much data the file contains. For example, a first file may have a first size of 5 MB while a second file that is smaller than the first file may have a size of 2 MB. Of course, these are merely examples of different sizes and a second file may be considered smaller than a first file for any case in which the second file contains less data than the first file.

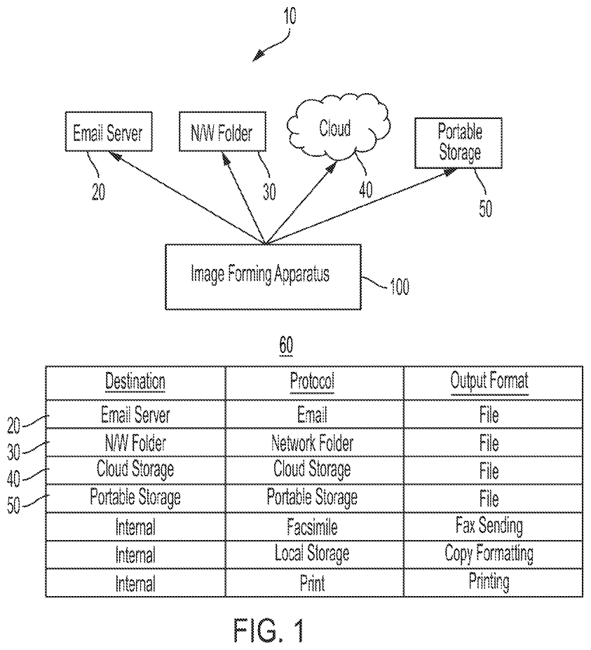

FIG. 1 illustrates a system including an image forming apparatus to provide files of different sizes to different destinations according to an example.

Referring to FIG. 1, an image forming apparatus 100 may be provided in a communication or networking system 10. The image forming apparatus 100 may communicate with an email server 20, a network storage device 30, a cloud-based storage device 40 (e.g., SharePoint™, Google Drive™, Huddle™, Glasscubes™, etc) or a portable storage device 50 (e.g., universal serial bus (USB) storage device). The image forming apparatus 100 may include a scan unit and a communication unit (not shown in FIG. 1) with which a document may be scanned and transmitted to multiple destinations such as the email server 20, the network storage device 30, the cloud-based storage device 40, or the portable storage device 50. The image forming apparatus 100 may also send the scanned document using a facsimile unit (not shown) of the image forming apparatus 100, may save digital image data of the scanned document to a local storage unit (not shown) of the image forming apparatus 100, or may print the scanned document using a print unit (not shown) of the image forming apparatus 100.

Depending on a destination of the scanned document, the image forming apparatus 100 will generate a different output format. For example, as illustrated in table 60, the image forming apparatus 100 will generate an output having a file format for the destinations of the email server 20, the network storage device 30, the cloud-based storage device 40, and the portable storage device 50. In contrast, the image forming apparatus 100 will generate an output that does not have a file format for the internal destinations of the facsimile unit, the local storage unit, and the print unit. In the cases of the facsimile unit, the local storage unit, and the print unit, the image forming apparatus 100 will generate an output having a format corresponding to those destinations (e.g., a printing format for the print unit).

In an example, a user may wish to transmit a scanned document to multiple destinations that each receives an output having the file format. For example, the user may wish to provide a scanned document to the portable storage device 50 and to the cloud-based storage device 40. In that case, the cloud-based storage device 40 may have a limitation as to a maximum size of a file that may be received whereas the portable storage device 50 may not have a size limitation. In various examples as described below, a user may provide a first file to the portable storage device 50 and a second file, having a smaller file size than the first file, to the cloud-based storage device 40. In that case, a possibility of an overloading, a transmission failure, etc. due to the larger size file being transmitted to the cloud-based storage device 40 having the size limitation is reduced.

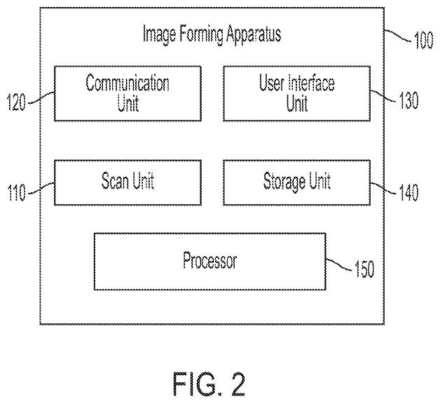

FIG. 2 illustrates an image forming apparatus according to an example.

Referring to FIG. 2, the image forming apparatus 100 may include a scan unit 110, a communication unit 120, a user interface (UI) unit 130, a storage unit 140, and a processor 150. The image forming apparatus 100 may include additional components that are not illustrated in FIG. 2 for sake of convenience. For example, the image forming apparatus 100 may include an image forming unit that includes the scan unit 110 as well as a print unit, a copy unit, and a facsimile unit. Furthermore, the image forming apparatus 100 may include a power supply, and the like.

The scan unit 110 may irradiate light onto a document and receive the light reflected therefrom to read the imagery on the document. As an example, an image sensor such as a charge coupled device (CCD) type sensor, a contact-type image sensor (CIS), or any other suitable type of image sensor may be used therein for image reading from a document. In various examples, the scan unit 110 may have a flatbed structure in which an image sensor is to move to read an image from a document page placed fixedly on a specific location, a document feed structure in which document sheets are to be fed to allow a fixedly positioned image sensor to read images therefrom, or a combination thereof.

The communication unit 120 may enable the image forming apparatus 100 to communicate with another device, e.g., the email server 20, the network storage device 30, the cloud-based storage device 40, or the portable storage device 50. The communication unit 120 may include various communication modules. For example, the communication unit 120 may include a wireless communication module or a wired communication module. The wireless communication module may be a module that supports, for example, Wi-Fi, Wi-Fi Direct, Bluetooth, Ultra-Wide Band (UWB), Long Term Evolution (LTE), Long Term Evolution-Advanced (LTE-A), 5G, Near Field Communication (NFC), etc., and the wired communication module may be a module that supports Local Area Network (LAN), Universal Serial Bus (USB), High-Definition Multimedia Interface (HDMI), etc. The communication unit 120 may be a transceiver.

The UI unit 130 may include an input unit to receive a variety of user inputs, e.g., a user input to perform a scan job, a user input to select a parameter of the scan job, a user input to select multiple destinations for the scan job, a selection to provide a smaller file to a destination, and the like. Examples of an input unit include a keyboard, a keypad, a physical button, a touch pad, a touch screen, a camera, a microphone, a reader to recognize a sticker, a barcode, etc., and any other type of device that can receive a variety of forms of user input.

The UI unit 130 may also include an output unit to output or provide a presentation of a UI to a user during a scan job and/or to output or provide information on, e.g., a result of the scan job or a status of the image forming apparatus 100. Examples of the output unit include a display panel, a speaker, and any other type of device that can provide a variety of outputs. In an example in which the input unit of the UI unit 130 is the touch screen, the output unit may be the same component as the input unit. In various examples, the output unit may display various menus with which to select parameters of a scan job, destinations of a scan job, an option to select a smaller size file of the scan job for a selected destination, and the like.

The storage unit 140 may include any computer-readable storage medium that stores data in a non-transitory form. In various examples, the storage unit 140 may be, for example, a random-access memory (RAM), a read-only memory (ROM), and/or any other type of storage medium. The storage unit 140 may have stored therein a variety of information, for example, a set of instructions that are to be executed by the processor 150, menus to be displayed by the UI unit 130, digital image data generated by the scan unit 110 during a scan job, a first file generated by the processor 150 using the digital image data, and the like. The processor 150 may execute an instruction stored in the storage unit 140. The processor 150 may also read other information stored in the storage unit 140. In addition, the processor 150 may store information in the storage unit 140 and may update information stored in the storage unit 140.

The processor 150 may control an operation of the image forming apparatus 100. For example, the processor 150 may receive a selection from the UI unit 130 to perform a scan job using the scan unit 110. Based on receipt of the scan job selection, the processor 150 may control the UI unit 130 to display menus for setting parameters of the scan job such as a resolution, a file type, a compression density, a compression factor, a color scheme, etc. The processor 150 may also control the UI unit 130 to display an address menu to select a destination of the scan job. In an example in which the user selects multiple destinations, the processor 150 may further control the UI unit 130 to display a menu with which the user may select to provide a smaller file to a destination.

Based on receipt of the input parameters, the processor 150 may control the scan unit 110 to start the scan job. In that case, the scan unit 110 may scan a document to output digital image data of the scanned document. Based on the digital image data and using the input parameters, the processor 150 may generate a first file having a first size. Furthermore, in a case in which the user has selected to provide a smaller file to a destination, the processor 150 may generate a second file having a second size that is smaller than the first size based on the digital image data. The processor 150 may also control the communication unit 120 to transmit the generated files to the corresponding destinations.

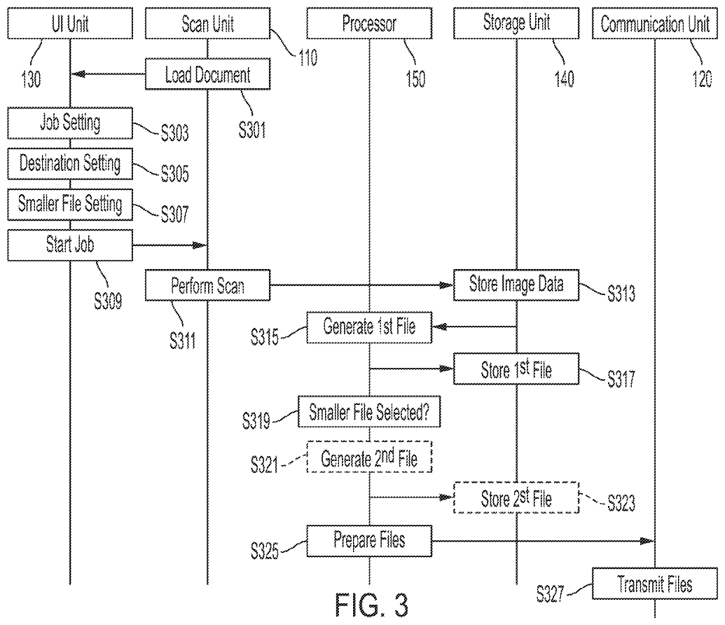

FIG. 3 illustrates an operation of an image forming apparatus to provide a scanned image to multiple destinations according to an example.

Referring to FIG. 3, a document to be scanned may be loaded on the scan unit 110 in operation S301. As an example, the document may be placed in a document feed structure of the scan unit 110 or placed on a platen or other feature of a flatbed structure of the scan unit 110. In operation S303, settings or parameters of the scanning job may be input by a user. As an example, a user interface may be displayed on the UI unit 130 with which the user may input parameters for the scan job. In various examples, the scan unit 110 may detect the loading of the document such that the UI unit 130 displays a user interface to receive the parameters or settings for the scan job. As another example, a user may select a scan icon displayed on an idle screen of the UI unit 130 to initiate the scan job, which will cause the UI unit 130 to display a user interface to receive the parameters or settings for the scan job. In various examples, operation S303 may occur before or after operation S301.

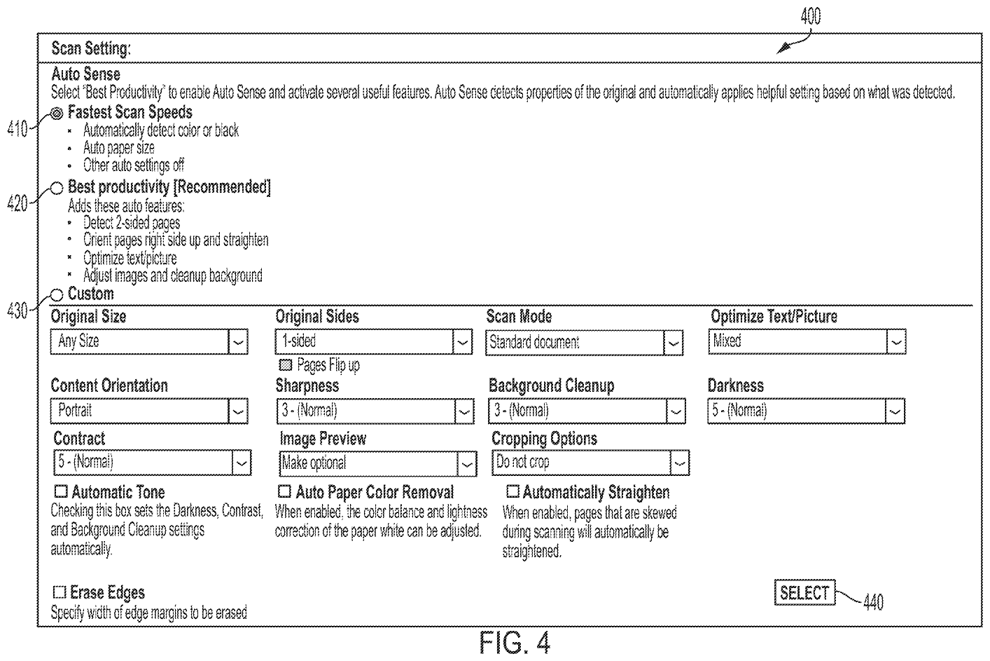

The user interface displayed in operation S303 may include different menus to select various parameters or settings for the scan job. FIG. 4 illustrates a user interface to receive parameters for a scan job according to an example.

Referring to FIG. 4, the UI unit 130 may display a job setting window 400 including various menus for selecting parameters for a scan job. The job setting window 400 may include a first option 410, a second option 420, and a third option 430. The first option 410 and the second option 420 may allow the user to select pre-set parameters based on a desired scanning result. For example, the first option 410 may correspond to a fastest scan speed option in which parameters are pre-set to support a quick scan. For example, for quick scan, other automatic settings may be turned off except for the minimum required automatic settings. The second option 420 may allow the user to select parameters that support a high productivity scan. To assist the user in determining whether to select the first option 410 or the second option 420, the job setting window 400 may display descriptions of the parameters associated with each of the first option 410 and the second option 420. For example, the first option 410 associated with a fast scan speed may include descriptions such as “automatically detect color,” “auto paper size,” and the like. The second option 420 associated with a high productivity scan may include descriptions such as “detect 2-sided pages,” “orient pages right side up,” and the like.

The third option 430 may be selected if the user desires to enter specific or custom parameters for the scan job. In that case, the user may set each of the available parameters as desired for the scan job. In the example illustrated in FIG. 4, parameters that may be selected using the third option 430 include a size of the original document, a number of sides of the original document (e.g., 1-sided, 2-sided), a scan mode (e.g., standard document, text only, picture, etc.), a selection to optimize for a text or a picture, a content orientation (i.e., portrait or landscape), a sharpness, a background cleanup, a darkness, a contrast, whether to display an image preview, a cropping option, and the like. The user interface associated with the third option 430 may further include menus to select different scanning options such as a color scheme (e.g., color, black/white, auto), a scanning resolution, a size of the document to be scanned, an indication of different sized original documents, a file format (e.g., JPEG, PDF, TIFF, etc.), a type of compression, a compression density, a compression factor, and the like. Upon completion of the parameter selection, the user may execute a select button 440 to input the selected parameters.

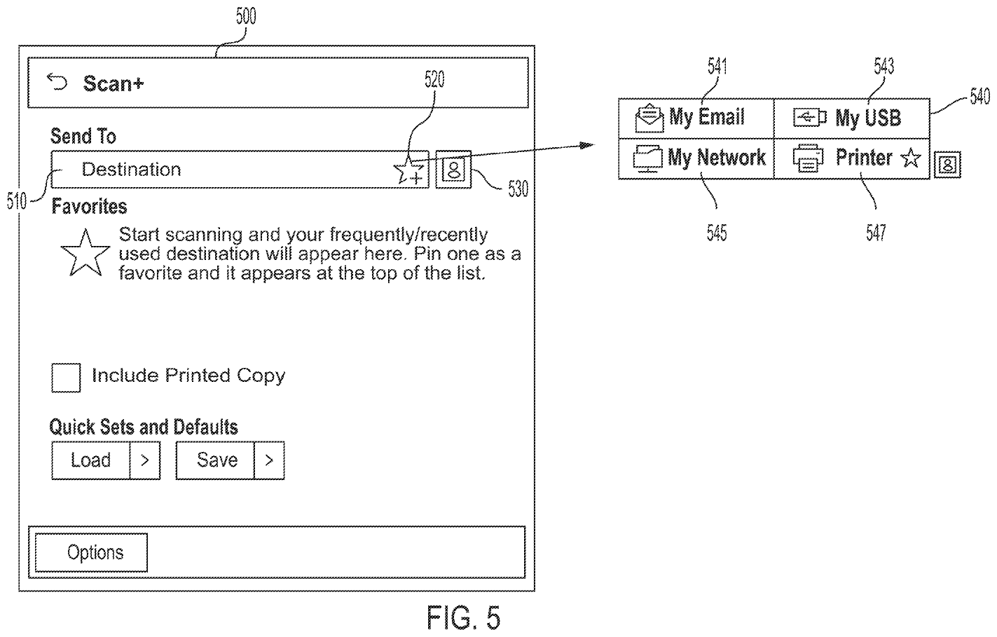

Referring again to FIG. 3, upon receipt of the selected parameters in operation S303, the UI unit 130 may provide a destination setting menu in operation S305. Using the destination setting menu, the user may select a destination that is to receive the scanned document. FIG. 5 illustrates a destination setting menu according to an example.

Referring to FIG. 5, a destination setting menu 500 may include different options with which a user may select destinations for the scanned document. For example, based on a user selecting the destination setting menu 500, the UI unit 130 may display a virtual keypad (not shown) to allow a user to input a destination. As an example, based on the user selecting an input window 510, the virtual keypad may be displayed to allow the user to type destination information such as a destination name, an email address of the destination, a uniform resource locator (URL) of a cloud storage device destination, a path of a network storage device destination, a path of a portable storage device destination (e.g., a USB connected to the image forming apparatus 100), and the like. In other examples, the destination setting menu 500 may include a favorites icon 520 with which to select frequently used destinations, an address book icon 530 that may display a list of addresses saved by the image forming apparatus 100 or a list of addresses associated with the user, and the like. The destination setting menu 500 may also receive an input selecting a facsimile, a local storage, or output by printing as a destination.

In the example of FIG. 5, a list of destinations 540 has been selected or input by the user. The list of destinations 540 includes an email destination 541, a portable storage (e.g., USB) destination 543, a network folder destination 545, and an output by printing destination 547. It is to be understood that this list of destinations 540 is merely an example and in no way limiting as to the number or type of destinations that may be selected.

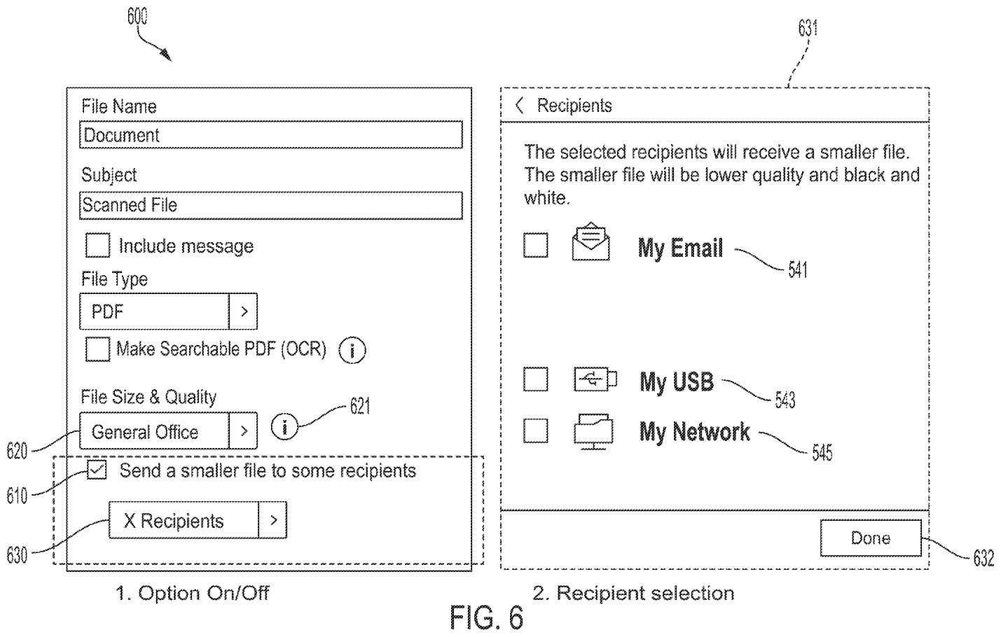

Referring again to FIG. 3, upon receipt of the selected destinations in operation S305, the UI unit 130 may provide a smaller file setting menu in operation S307. Using the smaller file setting menu, the user may select a destination that is to receive a smaller file. FIG. 6 illustrates a smaller file setting menu according to an example. It is to be understood that the term “a smaller file setting” is merely an example to provide different size files to the different destinations and in no way limiting. As other examples, “a high-quality image setting,” “a different file setting,” etc. can be used

Referring to FIG. 6, a smaller file setting menu 600 may be displayed after the selection of the destinations, such as the list of destinations 540 in FIG. 5. The smaller file setting menu 600 may include a selection setting button 610 that allows the user to select to send a smaller file to a destination. In the example of FIG. 6, the selection setting button 610 is illustrated as a box that may selected by the user, such as by using a virtual keypad. Upon selecting the selection setting button 610 to send a smaller file to a destination, additional menus may be activated for user access. For example, a file size and quality menu 620 and a recipients menu 630 may each be activated based on an input of the selection setting button 610 to send a smaller file to a destination.

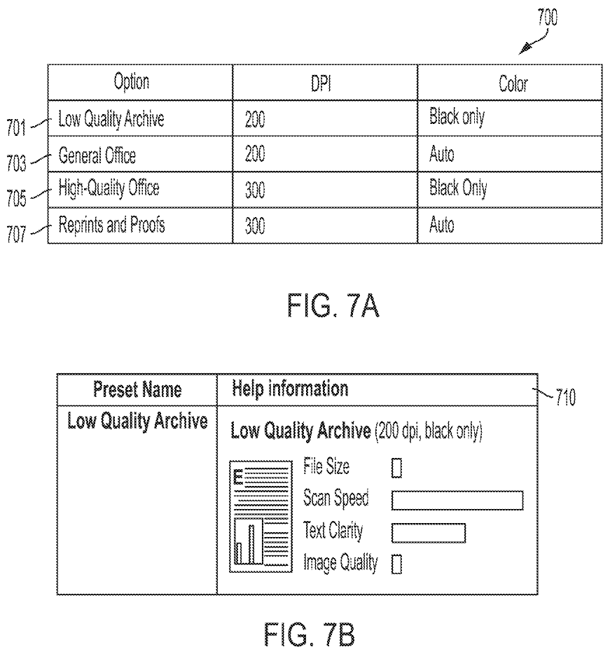

In an example, the file size and quality menu 620 may allow a user to select an option having certain pre-set parameters for the smaller file. FIG. 7A illustrates different options and associated pre-set parameters according to an example and FIG. 7B illustrates a help screen that may be displayed to assist a user in selecting an option having pre-set parameters according to an example.

Referring to FIG. 7A, the image forming apparatus 100 may have a set of options 700 stored in the storage unit 140. In the example of FIG. 7A, the set of options 700 includes a Low-Quality Archive option 701, a General Office option 703, a High-Quality Office option 705, and a Reprints and Proofs option 707. As illustrated in FIG. 7A, each of the pre-set options has a corresponding resolution (e.g., dots per inch) and a corresponding color option (e.g., color or black only). Of course, the set of options 700 illustrated in FIG. 7A is merely an example and is in no way limiting as to the number of options or the types or numbers of parameters associated with each option.

Referring to FIG. 7B, the UI unit 130 may display a help screen 710 to assist the user with a selection of an option having pre-set parameters. In an example, the help screen 710 may be displayed based on an input received on the smaller file setting menu 600, such as a selection of an information or help icon 621. In the example of FIG. 7B, the help screen 710 lists pre-set parameters associated with the Low-Quality Archive option 701. In this case, the help screen 710 illustrates that selection of the Low-Quality Archive option 701, which has pre-set parameters including a resolution of 200 dpi and a color option of black only, will result in a small file size, will allow for a fast scan speed, will provide a medium level of text clarity, and will provide a low level of image quality.

The file size and quality menu 620 may also allow a user to select an option to input custom parameters. In that case, the UI unit 130 may display a user interface similar to the user interface displayed upon selection of the third option 430 in FIG. 4. Using the custom option, a user may select the desired parameters to be used in creating a smaller file.

Based on an input of the selection setting button 610 to send a smaller file to a destination, the recipients menu 630 may also be activated. The recipients menu 630 allows a user to select a destination to receive the smaller file. Based on a selection of the recipients menu 630, a list of available destinations 631 may be displayed on the UI unit 130. The list of available destinations 631 is generated based on the list of destinations 540 the user selected from the destination setting menu 500 as well as a consideration of whether a destination included on the list of destinations 540 is able to receive a smaller file. That is, with reference to table 60 of FIG. 1, the smaller file option may be provided to destinations that receive an output having the file format. In the example of FIG. 1, the email server 20, the network storage device 30, the cloud-based storage device 40, and the portable storage device 50, which each receive an output having a file format, may receive the smaller file. Other destinations such as a facsimile device, a local storage device, or an output by printing, which do not receive an output having a file format, may not receive the smaller file.

Referring to FIGS. 5 and 6, the list of available destinations 631 includes the destinations from the list of destinations 540 that may receive an output having a file format. In the example of FIG. 5, the email destination 541, the portable storage device (e.g., USB) destination 543, and the network folder destination 545 each receives an output having a file format and are included in the list of available destinations 631. On the other hand, the output by printing destination 547 does not receive an output having a file format and is not included in the list of available destinations 631.

Based on the displayed list of available destinations 631, a user may select which of the available destinations are to receive the smaller file. In the example of FIG. 6, the list of available destinations 631 may include a check box adjacent each of the listed destinations that a user may select for the destinations that are to receive the smaller file. Based on the user finishing a selection of all desired destinations to receive the smaller file, the user may execute a done button 632 to input the selected destinations to receive the smaller file.

In the example of FIG. 6, the smaller file setting menu 600 may allow the user to select various options for the scan job such as a file name, a subject, whether to include a message when sending the scanned document to the destinations, a file type, and the like. In other examples, the selection of these options may be included in the job setting window 400.

Referring again to FIG. 3, upon completion of the job setting operation S303, the destination setting operation S305, and the selection of the smaller file option in operation S307, a command is sent to the scan unit 110 to start the scan job in operation S309. Based on receiving the job start command, the scan unit 110 performs the scan job in operation S311 and outputs digital image data of the scanned document to the storage unit 140. The storage unit 140 receives and stores the digital image data in operation S313. In operation S315, the processor 150 obtains the digital image data from the storage unit 140 and performs image processing to generate a first file. In an example, the generation of the first file in operation S315 may include applying the job setting parameters received in operation S303 to the digital image data obtained from the storage unit 140. Operation S315 may additionally include the performing of imaging work for a facsimile, a store in place, or a print destination that does not receive a file as an output format. In operation S317, the storage unit 140 receives the first file generated by the processor 150 and stores the first file.

In operation S319, the processor 150 determines if a smaller file option was selected in operation S307. Based on determining that the smaller file option was selected in operation S307, the processor 150 performs image processing to generate a second file in operation S321. For example, the image processing of operation S321 may include applying the smaller file setting parameters received in operation S307 to the digital image data obtained from the storage unit 140. In operation S323, the storage unit 140 receives the second file generated by the processor 150 and stores the second file. In an example, the process of FIG. 3 may additionally include preprocessing of the digital image data to be used for generating the first file in operation S315 and the second file in operation S321. For example, the processor 150 may obtain the digital image data from the storage unit 140 in operation S315, perform preprocessing of the digital image data (e.g., resolution conversion, color conversion, compression, etc.) to generate a preprocessed file, and use the preprocessed file to generate the first file in operation S315 and the second file in operation S321.

In operation S325, the processor 150 determines which destinations are to receive the first file or the second smaller file based on the user's selection received on the list of available destinations 631. Based on that determination, the processor 150 may associate the first file and the second file with a network address, a URL of a cloud-based storage device, an email address, or local address of a portable storage device associated with the corresponding destination. The processor 150 may also generate general job-related information such as a list of destinations, a time of transmittal, etc. and store the job-related information in a job log. Upon completion of operation S325, the processor 150 controls the communication unit 120 to transmit the appropriate files to the corresponding destinations in operation S327. In an example in which a first destination is to receive the first file and a second destination is to receive the second file, the transmission operation may proceed sequentially beginning with transmission of the first file to the first destination.

In the alternative, if the processor 150 determines in operation S319 that the smaller file option was not selected in operation S307, the processor 150 may associate the first file with all selected destinations and prepare the first file for transmission in operation S325. In that case, the communication unit 120 transmits the first file to all destinations in operation S327.

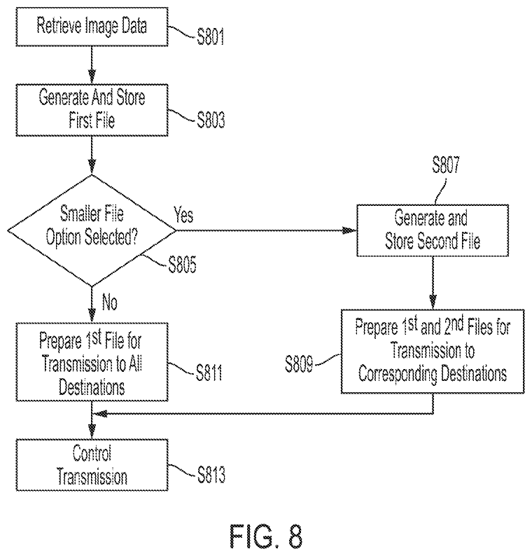

FIG. 8 illustrates an operation of a processor for optionally generating a first file and a second file according to an example.

Referring to FIG. 8, a processor may retrieve digital image data output by a scan unit in operation S801. Using the digital image data, the processor may generate and store a first file in operation S803. As an example, the processor may receive job setting parameters from a user and apply the parameters to the digital image data to generate the first file.

In operation S805, the processor determines if a smaller file option has been selected. Based on a selection of the smaller file option, the processor generates a second file by applying parameters associated with the smaller file option to the digital image data output by the scan unit and stores the generated second file in operation S807. In operation S809, the processor prepares the generated first file and second file for transmission to their corresponding destinations. For example, the processor may associate the first file and the second file with a network address, a URL of a cloud-based storage device, an email address, or local address of a portable storage device associated with the corresponding destination. In operation S815, the processor controls transmission of the first file and the second file to their corresponding destinations. For example, the processor may control a communication unit to transmit the first file and the second file.

Based on a determination in operation S805 that the smaller file option is not selected, the processor prepares the generated first file for transmission to each of the selected destinations. For example, the processor may associate the first file with an address of a network storage device, a URL of a cloud-based storage device, an email address, or a local address of a portable storage device associated with each of the selected destinations. In operation S813, the processor controls transmission of the first file to each of the selected destinations. For example, the processor may control a communication unit to transmit the first file.

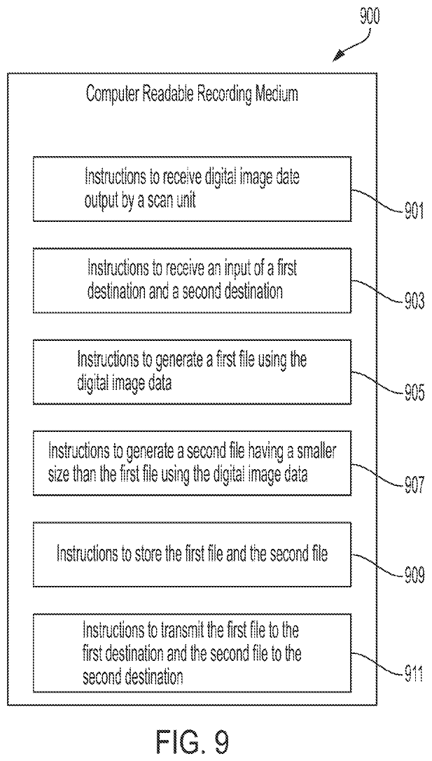

FIG. 9 is a diagram illustrating instructions stored in a computer readable recording medium according to an example.

Referring to FIG. 9, an example scan job executed in an image forming apparatus as described above may be implemented in the form of a computer or a computer readable recording medium which stores instructions or data executable by a processor. A computer readable recording medium 900 may store instructions associated with an operation of an image forming apparatus as described above. For example, the computer readable recording medium 900 may include instructions to receive digital image data output by a scan unit 901, instructions to receive an input of a first destination and a second destination 903, instructions to generate a first file using the digital image data 905, instructions to generate a second file having a smaller size than the first file using the digital image data 907, instructions to store the first file and the second file 909, and instructions to transmit the first file to the first destination and the second file to the second destination 911.

In various examples, the computer readable recording medium may include a read-only memory (ROM), a random-access memory (RAM), a flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, a magnetic tape, a floppy disk, a magneto-optical data storage device, an optical data storage device, a hard disk, a solid-state drive (SSD), and may store instructions or software, related data, data files, and data structures, and the computer readable recording medium may be any device capable of providing instructions or software, related data, data files, and data structures to the processor or the computer so that the processor or the computer may execute an instruction.

Examples of the disclosure have been illustrated and described. However, the disclosure is not limited to the above-described examples, and various changes in form and details may be made without departing from the spirit and scope as defined, by the following claims and their equivalents.

What is claimed is:

1. An image forming apparatus comprising:
a scan unit to output digital image data of a scanned document;
a user interface unit to receive an input of a first destination and a second destination;
a processor to:
generate a first file having a first size based on the digital image data, and
generate a second file having a second size based on the digital image data, the second size being smaller than the first size;
a storage unit to store the first file and the second file; and
a communication unit to transmit the first file to the first destination and the second file to the second destination.

2. The image forming apparatus of claim 1, wherein the user interface unit is further to receive an input to generate the second file having the smaller second size.

3. The image forming apparatus of claim 1, wherein the size of the first file and the size of the second file is determined based on a parameter of the respective file, the parameter including a file type, a resolution, an image quality, a compression density, a compression factor, or a color scheme.

4. The image forming apparatus of claim 3, wherein the user interface unit is further to receive an input of at least one parameter for each of the first file and the second file.

5. The image forming apparatus of claim 1, wherein each of the first destination and the second destination comprises an email server, a network storage device, a cloud-based storage device, or a portable storage device.

6. The image forming apparatus of claim 1, wherein the processor is further to generate a third file for a third destination based on the digital image data, the third file having a third size different from the first size and the second size.

7. The image forming apparatus of claim 1,
wherein the processor is to generate a preprocessed file using the digital image data, and
wherein each of the first file and the second file is generated using the preprocessed file.

8. An image forming apparatus comprising:
a scan unit to output digital image data of a scanned document;
a user interface unit to receive an input including a plurality of destinations for the scanned document;
a processor to generate a first file and a second file based on the scanned document, the second file having at least one parameter setting different from the first file;
a storage unit to store the first file and the second file; and
a communication unit to respectively transmit the first file and the second file to a first destination and a second destination of the plurality of destinations.

9. The image forming apparatus of claim 8, wherein the parameters of each of the first file and the second file include a file type, a resolution, an image quality, a compression density, a compression factor, or a color scheme.

10. The image forming apparatus of claim 9, wherein the processor is to:
generate the first file based on the digital image data and a first parameter setting, and
generate the second file based on the digital image data and a second parameter setting,
wherein the second file has a smaller file size than the first file.

11. The image forming apparatus of claim 8, wherein each of the plurality of destinations comprises an email server, a network storage device, a cloud-based storage device, or a portable storage device.

12. The image forming apparatus of claim 8, wherein the user interface unit is further to receive a selection to create files having different parameters.

13. The image forming apparatus of claim 12, wherein the processor is to generate a plurality of files respectively for the plurality of destinations and each of the plurality of files has a different set of parameters than the other files.

14. A non-transitory machine-readable storage medium encoded with instructions executable by a processor, the non-transitory machine-readable storage medium comprising:
instructions to output digital image data of a scanned document;
instructions to receive an input of a first destination and a second destination for the scanned document;
instructions to generate a first file having a first size based on the digital image data;
instructions to generate a second file having a second size, the second size being smaller than the first size, based on the digital image data;
instructions to store the first file and the second file; and
instructions to transmit the first file to the first destination and the second file to the second destination

15. The non-transitory machine-readable storage medium of claim 14, wherein the size of the first file and the size of the second file is determined based on a parameter of the respective file, the parameter including a file type, a resolution, an image quality, a compression density, a compression factor, or a color scheme.
